(19) United States
(12) Patent Application Publication
(10) Pub. No.: US 2014/0181780 A1
(43) Pub. Date: Jun. 26, 2014

(54) ELECTROMIGRATION ANALYSIS FOR STANDARD CELL BASED DESIGNS

(71) Applicant: ADVANCED MICRO DEVICES, INC., Sunnyvale, CA (US)

(72) Inventors: Thomas D. Burd, Fremont, CA (US); Srinivasaraghavan Srini Krishnamoorthy, Mountain View, CA (US); Vishak K. Venkatraman, San Jose, CA (US); Yuri Apanovich, San Jose, CA (US); James A. Pistole, San Jose, CA (US); Rajit C. Chandra, Cupertino, CA (US)

(73) Assignee: ADVANCED MICRO DEVICES, INC., Sunnyvale, CA (US)

(21) Appl. No.: 13/725,121

(22) Filed: Dec. 21, 2012

(51) Int. Cl. G06F 17/50

(52) U.S. Cl. CPC G06F 17/5045
USPC 716/136

(57) ABSTRACT

Methods and media for analyzing electrical designs are provided. A method includes and the media are configured for providing or loading to an analysis tool a design that includes a plurality of cell instances of a standard cell and estimating a failure rate of the design using in context electrical parameters for the plurality of cell instances and a parameterized electromigration (EM) view of the standard cell. Another method includes providing a standard cell of a standard cell library and characterizing the standard cell to create a parameterized thermal model to compute a temperature of an internal structure of the standard cell and a parameterized current model to compute a current through the internal structure of the standard cell given in context electrical parameters.

### TECHNICAL FIELD

The technical field relates generally relates to analysis of standard cell based integrated circuit designs, and more particularly to electromigration analysis of standard cell based designs using in context electrical parameters.

### BACKGROUND

In integrated circuit designs, metal interconnects and transistors are subject to ever increasing current densities and temperature. The interconnects and transistors may wear out over a period of time causing chip-level failures. Electromigration is a known interconnect wear-out mechanism caused by movement of metal atoms under high current and thermal gradients. Time-dependent dielectric breakdown (TDDB) in transistors can occur due to continuous application of electric fields across the oxide layer, often resulting in permanent circuit failure. Similarly, hot carrier injection (HCI) effects in transistors that affect carrier mobility are often caused by carrier trapping inside the gate oxide or the SiO₂ layer due to the continuous application of high drain to source bias. In addition, bias temperature instability (BTI) that manifests itself at high temperatures as a shift in threshold voltage in transistors causes temporary timing failures in the design. Such failure mechanisms often place constraints on the DC current density that an interconnect line can support, or the maximum electric field that a transistor can support. In addition, Joule heating can reduce mean time to failure (MTTF) of interconnects and transistors, and can place constraints on the root mean squared (RMS) current density that an interconnect line or a transistor can support.

Accurately solving DC and RMS currents in each interconnect segment via circuit simulation can be a computationally intensive task for large integrated circuit (IC) designs. A transistor level analysis may be time prohibitive. Existing standard cell based analysis requires pre-characterization of every electrical parameter of interest in a standard cell based design, and may only provide current limit violations. Accordingly, existing analysis method are typically inflexible and may not accurately predict failure rates of interconnects and transistors. The standard cell based analysis further typically does not analyze thermal interaction between the internals of standard cell instances and neighboring structures.

### SUMMARY OF EMBODIMENTS

Methods and media for analyzing electrical designs are provided. In some embodiments a method includes generating, by an analysis tool, an estimate of a failure rate of a design that includes a plurality of cell instances of a standard cell using in context electrical parameters for the plurality of cell instances and a parameterized electromigration (EM) view of the standard cell.

In some embodiments a method includes characterizing a standard cell to create a parameterized thermal model to compute a temperature of an internal structure of the standard cell and a parameterized current model to compute a current through the internal structure of the standard cell given in context electrical parameters.

In some embodiments a non-transitory computer readable medium is provided. The non-transitory computer readable medium stores control logic for execution by a processor. The control logic includes instructions to generate an estimate of a failure rate of the design using in context electrical parameters for the plurality of cell instances and a parameterized electromigration (EM) view of the standard cell.

### BRIEF DESCRIPTION OF THE DRAWINGS

Advantages of the embodiments disclosed herein will be readily appreciated, as the same becomes better understood by reference to the following detailed description when considered in connection with the accompanying drawings wherein:

FIG. 1 is a simplified block diagram of a computer system according to some embodiments;

FIG. 2 is a simplified flow diagram of an analysis flow according to some embodiments;

FIG. 3 is a graphical view of a temperature in a cell according to some embodiments; and

FIG. 4 is a flow diagram illustrating a method according to some embodiments.

### DETAILED DESCRIPTION

The following detailed description is merely exemplary in nature and is not intended to limit application and uses. As used herein, the word “exemplary” means “serving as an example, instance, or illustration.” Thus, any embodiments described herein as “exemplary” are not necessarily to be construed as preferred or advantageous over other embodiments. All of the embodiments described herein are exemplary embodiments provided to enable persons skilled in the art to make or use the disclosed embodiments and not to limit the scope of the disclosure which is defined by the claims. Furthermore, there is no intention to be bound by any expressed or implied theory presented in the preceding technical field, background, brief summary, the following detailed description or for any particular computing system.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language.

Finally, for the sake of brevity, conventional techniques and components related to computing systems and other functional aspects of a computing system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in the embodiments disclosed herein.

Methods and media are provided for a hierarchical thermal and electromigration analysis flow to predict a failure rate of interconnect metals, vias, and devices in standard cell based designs. Parameterized current densities and thermal gradients are obtained during pre-characterization of individual standard cells and may be used to compute the interconnect failure rate of standard cell-based designs, thereby lowering guard-banding in addition to reducing runtime and memory requirements. The method may be used, for example, to evaluate electronic hardware designs that use metal interconnects and may include transistors. Such designs operating may have electromigration and device reliability issues that may be estimated using the method provided herein.

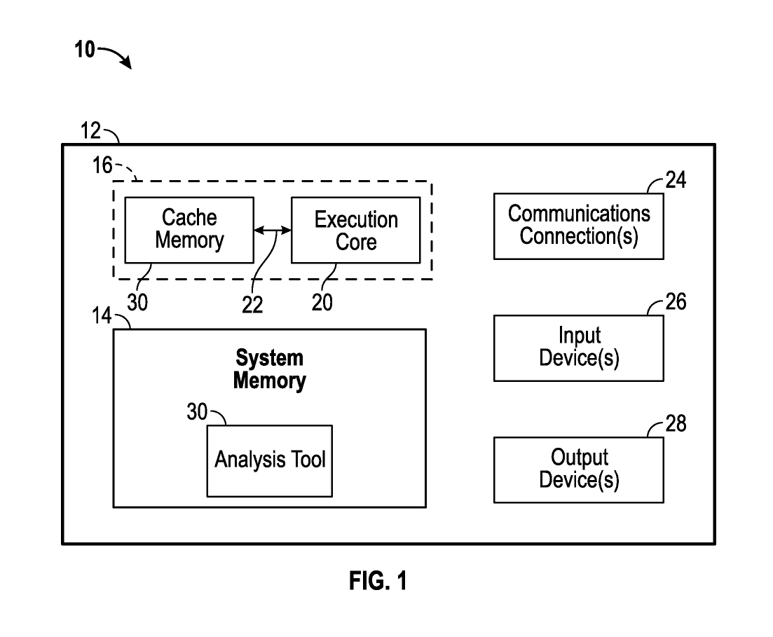

Referring now to FIG. 1, a simplified block diagram is shown illustrating a computer system 10 according to some embodiments. Computer system 10 and certain aspects of the embodiments provided herein may be described in the general context of computer-executable instructions, such as program modules, application code, or software executed by one or more computers or other devices. Generally, program modules include routines, programs, objects, components, data structures, and/or other elements that perform particular tasks or implement particular abstract data types. Typically, the functionality of the program modules may be combined or distributed as desired in various embodiments.

The computer system 10 includes a case or housing 12, system memory 14, and a processor 16. The computer system 10 may be a desktop computer, laptop computer, server, set top box, motherboard, or any other device that includes the processor 16. Additional components such as displays and user input components may be employed without departing from the scope of the present disclosure. The system memory 14 in the example illustrated is a dynamic random-access memory (“DRAM”) that communicates with the processor 16, although other memory technologies could be used. The processor 16 includes at least one execution core 20, an interconnect 22, and a cache memory 24. The processor 16 may be a central processor unit, a graphics processing unit, an accelerated processing unit, or any other suitable processor type.

The computer system 10 may also contain communications connection(s) 24 that allow the system to communicate with other devices. In embodiments described herein, communication connection(s) 24 may include, without limitation, suitably configured interfaces that allow computer system 10 to communicate with a network such as the Internet, external databases, external memory devices, and the like. Communications connection(s) 24 may be associated with the handling of communication media as defined above. The computer system 10 may also include or communicate with input device(s) 26 such as a keyboard, mouse or other pointing device, pen, voice input device, touch input device, etc. The computer system 10 may also include or communicate with output device(s) 28 such as a display, speakers, printer, or the like. All of these devices are well known in the art and need not be discussed at length here.

The computer system 10 may be used to perform the analysis of the embodiments described herein. For example, an analysis tool 30 may be stored in the system memory 14 and run on the processor 16.

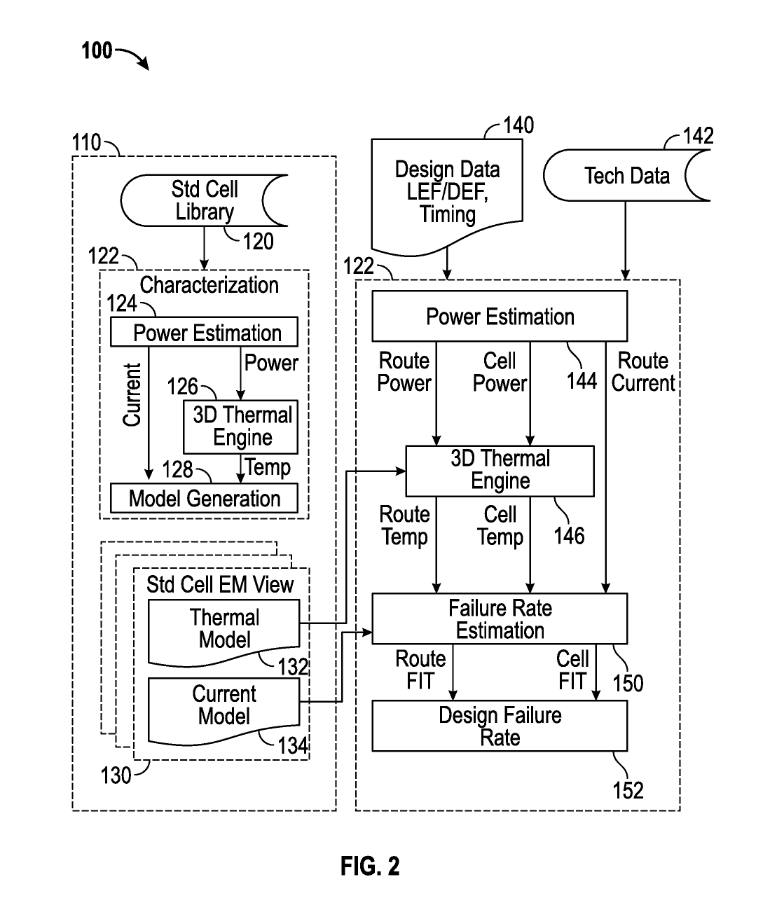

Referring now to FIG. 2, a simplified diagram of an analysis flow 100 is illustrated according to some embodiments. The analysis flow 100 is a hierarchical thermal and electromigration (EM) analysis flow that includes a standard cell library characterization phase 110 and a standard cell-based EM analysis phase 112. The flow may be used to determine a failure rate of an interconnect segment based on temperature and current density. The method is context sensitive for voltage, frequency, temperature, and other context data. The hierarchical model permits fast runtimes and permits addressing reliability issues such as electromigration (EM), time dependent dielectric breakdown (TDDB), positive/negative bias temperature instabilities (PBTI/NBTI), hot carrier injection (HCI), stress migration, etc.

The characterization phase 110 includes characterization 122 of standard cells of a standard cell library 120. In the example provided, the characterization 122 includes power estimation 124, a 3D thermal engine 126, and model generation 128, as will be appreciated by those skilled in the art.

The characterization 122 further creates an EM view 130 for each standard cell. The EM view 130 contains information required to compute a failure rate when given a set of in-context electrical, thermal, and design parameters. Each cell contains data such as downstream capacitance as a function of capacitance load on the cell, current limits, and temperature rise annotated on the internal structures of interest. Accordingly, by providing the parameters, the standard cells need not be characterized for each and every possible parameter that may be used in a standard cell design. The parameters may be used for failure rate analysis in the analysis phase 112, as will be described below. By using the EM view 130, the flow 100 may reduce overly pessimistic failure rate estimations and reduce runtimes. For example, without the EM view 130, a runtime may be prohibitive because current and failure in trillion hours (FIT) calculations may need to be performed for each instance.

The EM view 130 includes a thermal model 132 and a current model 134 for computing the failure rate of the standard cell given the electrical parameters used by the cell instances in the analyzed design. Via interfaces may be the first mode of failures. Accordingly, in some embodiments, the EM view 130 is stored only for via interfaces in the standard cells and includes a collection of all metal and via resistors connected to the via location. In some embodiments, metals may result in failures and in such cases metals may also be stored.

The thermal model 132 generally indicates the temperature in the standard cell for a given voltage, frequency, and load on the cell instance of the cell based design. The model may contain values and/or analytical functions. The thermal model includes the total capacitance of the standard cell to enable power calculation for thermal analysis in the standard cell-based design. In some embodiments the thermal model 132 further includes a subset of layout geometries to improve accuracy. In some embodiments, the subset of layout geometries is omitted to decrease run times of the analysis. Further parameters may be obtained when the standard cell is instantiated.

The temperature of an interconnect segment in the standard cell depends on the self-heating effect and thermal diffusion (mutual heating) from a neighboring interconnect structure. The self-heating effect depends on the geometric volume of interconnect. The self-heating effect also depends on power; which depends on capacitance, voltage, frequency and switching factor of the cell. Mutual heating may occur due to thermal diffusion through the inter-layer dielectric when the cell is aggressed upon by another interconnect segment. The effect of the self and internal mutual heating may be evaluated in the characterization phase 122 by separating the self and internal mutual heating effects from a reference temperature that is caused by external effects. Accordingly, in the example provided, the analytical functions for self and internal heating effects for each via interface are included in the thermal model 132.

The current model 134 generally indicates the current on a particular resistor inside the standard cell for a given electrical context, such as voltage, frequency, and load. The current model 134 contains information needed to compute the DC current density of the via interface. The current density is the ratio of actual current to the current limit. The current limit is a function of wire dimension, which may be stored directly in the current model 134.

The DC current is a function of the capacitance, voltage, frequency and switching factor. Of these, the capacitance term may be expressed as an analytical function of parasitic capacitance and a variable load capacitance. The switching factor of each net in the standard cell may be expressed as a function of switching factors of its inputs. The switching factor function, capacitance function, and the current density stored for each via interface in the standard cell are included in the current model 134. Further parameters may be obtained when the standard cell is instantiated.

In general, the analysis phase 112 uses the EM view 130 of all the standard cell instances and the interconnects between the cell instances to compute the failure rate of standard cell-based designs. The analysis phase 112 adapts the EM view 130 for use in a suitable failure rate analysis method. For example, the transistor level analysis method described in US Patent Application Publication 2012/0096424 to Burd et al., the disclosure of which is hereby incorporated by reference, may be adapted for the hierarchical analysis described herein. The analysis phase 112 adapts the transistor level analysis to a hierarchical analysis of standard cells and inter-cell metal routing where the structures inside the cell-instances are abstracted away for runtime purposes. Computing the failure rate on the internals of the standard cells may be performed with knowledge of via interfaces, currents with associated rises in temperature, and neighborhood temperature.

The analysis phase 112 takes design data 140 and technology data 142 as inputs. The design data 140 may include a layout as a combination of library design exchange format (LEF) and design exchange format (DEF), or may be provided in other formats as will be appreciated by those skilled in the art. The technology data 142 may include parameters such as thickness, mask layer information, and material properties such as thermal conductivities.

A design-level power estimation 144 is then imposed on the standard cell based design. The power estimation 144 passes route power and cell power to a 3D thermal engine 146. The power estimation 144 further passes route current information to a failure rate estimation 150.

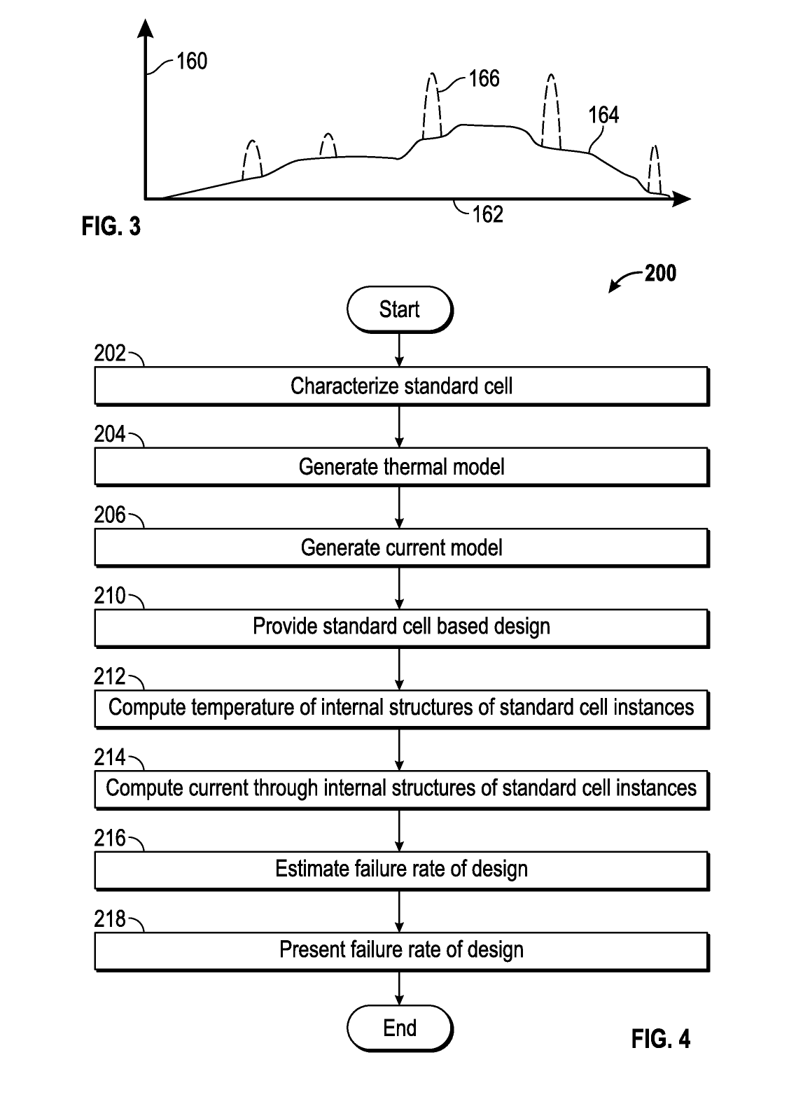

Referring now to FIG. 3, and with continued reference to FIG. 2, a graph illustrates a temperature 160 of a standard cell as a function of a distance 162 into the standard cell as computed by the 3D thermal engine 146. The temperature of the interconnect may be determined by computing the analytical functions of the heating effects provided by the thermal model 132 combined with external mutual heating effects. The external mutual heating effects may be caused by a preset substrate temperature and/or by a hot neighbor.

A reference temperature 164 is initially computed by the 3D thermal engine 146 using the inter-cell routing power as well as the power on the footprint of the cell instances. During standard cell-based analysis 112, the footprints of the standard cell instances are loaded with any layout geometries that may be stored in the corresponding thermal model 132. Power numbers are then computed using the total capacitance stored in the thermal models and the in-context capacitance loads on the cell instance.

The 3D thermal engine 146 then computes a relative excursion temperature 166 within the standard cell using the analytical heating effect functions of the thermal model 132 along with in-context electrical parameters (e.g., voltage, frequency, etc.). The temperature of an interconnect in the standard cell may then be computed as the sum of the reference temperature 164 and the relative excursion temperature 166.

At the failure rate estimation 150, the failure rate of inter-cell routes may be computed using the FIT calculation method described in US Patent Application Publication 2012/0096424. For the via interfaces inside cell-instances, DC current densities may be computed using the current limits stored in the current model 134 of the EM view 130. The parameterized DC current functions of the current model 134 and the in-context electrical parameters such as voltage, frequency, switching factors, and load capacitance are then used to compute the current densities. The temperature of the via interfaces computed in the 3D thermal engine 146 is used along with the DC current densities for computation in the failure rate estimation 150. The failure rate is presented at the design failure rate 152. It should be appreciated that a design in which some wires violate current limits may still pass a failure rate constrain in a statistical manner.

Table 1 provides a comparison of results obtained for a 32 nm design using a flat transistor level analysis and the hierarchical analysis presented herein. As can be seen, the flat transistor level run takes about a day to perform high resolution temperature calculation. Similar results (e.g., within about four degrees Celsius) may be captured in a few hours using the hierarchical analysis. The runtime for the characterization phase 110 adds several hours to the overall analysis runtime, but will be a minimal overhead when applied to all standard cell-based designs in a processor.

TABLE 1

| | Flat Design | | | Hierarchical Design | | |
|---|---|---|---|---|---|---|
| Designs | Instances | Nets | Runtime (Hrs) | Instances | Nets | Runtime (hrs) |
| Design 1 | 703897 | 132704 | 21:19 | 30417 | 34319 | 01:52 |
| Design 2 | 1131849 | 283216 | 25:14 | 52981 | 61274 | 03:53 |

Referring now to FIG. 4, a method 200 for standard cell based design analysis is illustrated in flow diagram form. In the example provided, the method 200 is implemented by the computer system 10 as the analysis tool 30. At block 202 a standard cell is characterized. For example, the standard cell may be characterized in the characterization 122 of the characterization phase 110. A thermal model is generated at block 204 and a current model is generated at block 206. For example, the thermal model 132 and the current model 134 may be generated.

At block 210 a standard cell based design is provided to an analysis tool. In some embodiments, providing the design The design includes a plurality of instances of the standard cell that was characterized in block 202. For example, the design data 140 and technology data 142 may be provided to a software tool programmed to perform the analysis phase 112.

The temperature of internal structures of the cell instances are computed at block 212 and the currents through the internal structures are computed at block 214. For example, the temperatures may be computed by the 3D thermal engine 146 using the thermal model 132 and the in context electrical parameters. Similarly, the currents may be computed at the failure rate estimation 150 using the current model 134 and the in context electrical parameters.

The failure rate of the design is computed at block 216 and presented at block 218. For example, the failure rate estimation 150 may compute the failure rate of the design and the failure rate may be presented by the design failure rate 152.

A data structure representative of the computer system 10 and/or portions thereof included on a computer readable storage medium may be a database or other data structure which can be read by a program and used, directly or indirectly, to fabricate the hardware comprising the computer system 10. For example, the data structure may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the computer system 10. The netlist may then be placed and routed to produce a data set describing geometric shapes to be applied to masks. The masks may then be used in various semiconductor fabrication steps to produce a semiconductor circuit or circuits corresponding to the computer system 10. Alternatively, the database on the computer readable storage medium may be the netlist (with or without the synthesis library) or the data set, as desired, or Graphic Data System (GDS) II data.

The method illustrated in FIG. 4 may be governed by instructions that are stored in a non-transitory computer readable storage medium and that are executed by at least one processor of a computing system. Each of the operations shown in FIG. 4 may correspond to instructions stored in a non-transitory computer memory or computer readable storage medium. In various embodiments, the non-transitory computer readable storage medium includes a magnetic or optical disk storage device, solid state storage devices such as Flash memory, or other non-volatile memory device or devices. The computer readable instructions stored on the non-transitory computer readable storage medium may be in source code, assembly language code, object code, or other instruction format that is interpreted and/or executable by one or more processors.

The methods and media provided herein have several beneficial attributes. For example, pre-characterizing cells for current densities and relative temperature excursions facilitates accurately capturing the failure rate of cell instances using in context electrical and design parameters. In addition, the enhancement to transistor level analysis may be a critical enabling technology for chip-level failure rate roll-up in sub-45nm microprocessor designs. Furthermore, the embodiments disclosed herein facilitate providing feedback to library teams on the failure rate of devices and interconnects used inside standard cells.

While at least one exemplary embodiment has been presented in the foregoing detailed description of the disclosed embodiments, it should be appreciated that a vast number of variations exist. It should also be appreciated that the exemplary embodiment or exemplary embodiments are only examples, and are not intended to limit the scope, applicability, or configuration of the disclosed embodiments in any way. Rather, the foregoing detailed description will provide those skilled in the art with a convenient road map for implementing the disclosed embodiments, it being understood that various changes may be made in the function and arrangement of elements of the disclosed embodiments without departing from the scope of the disclosed embodiments as set forth in the appended claims and their legal equivalents.

1. A method comprising:
generating, by a processor performing operations for an analysis tool, an estimate of a failure rate of a design that includes a plurality of cell instances of a standard cell using in context electrical parameters for the plurality of cell instances and a parameterized electromigration (EM) view of the standard cell, the estimate including external heating effects on each cell instance of the standard cell caused by at least one of a substrate or a neighbor at corresponding temperatures.

2. The method of claim 1 wherein generating the estimate of the failure rate further includes computing temperatures of internal structures of the plurality of cell instances using a thermal model of the standard cell.

3. The method of claim 2 wherein computing temperatures further includes computing a reference temperature and computing a relative excursion temperature within the plurality of cell instances using the thermal model and the in context electrical parameters of the design.

4. The method of claim 2 wherein generating the estimate of the failure rate further includes computing currents through the internal structures of the plurality of cell instances using a current model of the standard cell and in context electrical parameters of the design.

5. The method of claim 4 wherein generating the estimate of the failure rate of the design using in context electrical parameters includes generating an estimate of the failure rate of the design using at least one of voltage, frequency, switching factors, and load capacitance of the plurality of cell instances.

6. The method of claim 1 further including characterizing the standard cell to create the parameterized electromigration (EM) view.

7. The method of claim 6 wherein characterizing the standard cell includes generating a thermal model that includes analytical functions for self and internal mutual heating effects for internal structures of the standard cell using the in context electrical parameters of the design.

8. The method of claim 6 wherein characterizing the standard cell includes generating a current model that includes a switching factor function, a capacitance function, and a current density function for internal structures of the standard cell using the in context electrical parameters of the design.

9. A method comprising:
by a processor, performing operations for:
characterizing a standard cell to create a parameterized thermal model to compute a temperature of an internal structure of the standard cell, and to create a parameterized current model to compute a current through the internal structure of the standard cell given in context electrical parameters, wherein the parameterized thermal model includes external heating effects on the standard cell caused by at least one of a substrate or a neighbor at corresponding temperatures.

10. The method of claim 9 wherein characterizing the standard cell to create a parameterized thermal model includes generating a thermal model that includes analytical functions for self and internal mutual heating effects for the internal structure of the standard cell using in the context electrical parameters of the design.

11. The method of claim 9 wherein characterizing the standard cell to create a parameterized current model includes generating a current model that includes a switching factor function, a capacitance function, and a current density function for the internal structure of the standard cell using the in context electrical parameters of the design.

12. A non-transitory computer readable medium storing control logic for execution by a processor, the control logic comprising instructions to:
generate an estimate of a failure rate of a design that includes a plurality of cell instances of a standard cell using in context electrical parameters for the plurality of cell instances and a parameterized electromigration (EM) view of the standard cell, the estimate including external heating effects on each cell instance of the standard cell caused by at least one of a substrate or a neighbor at corresponding temperatures.

13. The computer readable medium of claim 12 wherein the control logic includes instructions to compute temperatures of internal structures of the plurality of cell instances using a thermal model of the standard cell.

14. The computer readable medium of claim 13 wherein the control logic includes instructions to compute a reference temperature and compute a relative excursion temperature within the plurality of cell instances using the thermal model and the in context electrical parameters of the design.

15. The computer readable medium of claim 12 wherein the control logic includes instructions to compute currents through internal structures of the plurality of cell instances using a current model of the standard cell and in the context electrical parameters of the design.

16. The computer readable medium of claim 12 wherein the control logic includes instructions to analyze at least one of time dependent dielectric breakdown, bias temperature instabilities, hot carrier injection, and stress migration in the design.

17. The computer readable medium of claim 16 wherein the control logic includes instructions to estimate the failure rate of the design using at least one of voltage, frequency, switching factors, and load capacitance of the plurality of cell instances.

18. The computer readable medium of claim 12 wherein the control logic includes instructions to characterize the standard cell to create the parameterized EM view that includes a thermal model and a current model.

19. The computer readable medium of claim 18 wherein the control logic includes instructions to generate the thermal model that includes analytical functions for self and internal mutual heating effects for internal structures of the standard cell using the in context electrical parameters of the design.

20. The computer readable medium of claim 12 wherein the control logic includes instructions to generate the current model that includes a switching factor function, a capacitance function, and a current density function for internal structures of the standard cell using the in context electrical parameters of the design.
